(19) United States
(12) Patent Application Publication
(10) Pub. No.: US 2008/0248388 A1
(43) Pub. Date: Oct. 9, 2008

(54) ELECTRODE FOR ELECTROCHEMICAL ELEMENT AND ELECTROCHEMICAL ELEMENT USING THE SAME

(76) Inventors: Takashi Ohtsuka, Osaka (JP); Kaoru Nagata, Osaka (JP); Hideharu Takezawa, Nara (JP); Shoichi Imashiku, Osaka (JP)

Correspondence Address: MCDERMOTT WILL & EMERY LLP, 600 13TH STREET, NW, WASHINGTON, DC, 20005-3096, US

(21) Appl. No.: 12/098,126

(22) Filed: Apr. 4, 2008

(30) Foreign Application Priority Data
Apr. 5, 2007 (JP) 2007-099139

(51) Int. Cl. H01M 4/24; H01M 4/38

(52) U.S. Cl. 429/218.1; 429/209

(57) ABSTRACT

The invention presents an electrode for an electrochemical element for inserting and extracting a lithium ion reversibly, comprising a current collector forming a concave portion and a convex portion at least on one side, and a columnar body including an active material formed on the convex portion of the current collector, in which the columnar body covers at least a part of respective sides of the convex portion. By this configuration, an electrode for an electrochemical element of long life and excellent reliability is realized.

### BACKGROUND OF THE INVENTION

1. Field of the Invention

The present invention relates to a manufacturing method of an electrode for an electrochemical element of high capacity and excellent in charging and discharging cycle characteristics

2. Background Art

Recently, a lithium ion secondary battery representing a nonaqueous electrolyte secondary battery is widely used, for example, as an electrochemical element because it is light in weight, high in electromotive force, and high in energy density. For example, as a driving power source for portable telephones, digital cameras, video cameras, laptop computers, and various portable electronic appliances and mobile communication devices or the like, the demand for the lithium ion secondary battery is increasing.

The lithium ion secondary battery is composed of a positive electrode made of composite oxide containing lithium, a negative electrode containing lithium metal, lithium alloy, or negative electrode active material for inserting and extracting lithium ions, and an electrolyte.

Instead of carbon materials such as graphite conventionally used as the negative electrode material, lately, much has been reported about elements having an inserting performance of lithium ions and having a theoretical capacity density of more than 833 mAh/cm³. For example, elements of negative electrode active material having a theoretical capacity density of more than 833 mAh/cm³ include silicon (Si), tin (Sn), germanium (Ge) forming an alloy with lithium, and their oxides and alloys. In particular, Si particles, silicon oxide particles, and other particles containing silicon are inexpensive, and are widely studied.

These elements are, however, increased in volume when inserting lithium ions when charging. For example, if Si is used as negative electrode active material, when lithium ions are inserted to a maximum capacity, it is expressed as Li_{4.4}Si, and by transforming from Si to Li_{4.4}Si, its volume is increased by 4.12 times of the discharged state.

Accordingly, when a negative electrode active material is formed by depositing a thin film of the element on a current collector by CVD method or sputtering method, in particular, the negative electrode active material expands and contracts by insertion and extraction of lithium ions, and peeling may occur due to decrease of adhesion between the negative electrode active material and the negative electrode current collector in the course of repetition of charging and discharging cycles.

To solve this problem, for example, Unexamined Japanese Patent Publication No. 2003-17040 (hereinafter referred to as “patent document 1”) discloses a method of forming undulations on the surface of a current collector, depositing a thin film of negative electrode active material thereon, and forming a gap in a thickness direction by etching. Similarly, Unexamined Japanese Patent Publication No. 2004-127561 (hereinafter referred to as “patent document 2”) discloses a method of forming undulations on the surface of a current collector, forming a resist pattern so that a position of the convex portion may be an opening, electrodepositing a thin film of negative electrode active material thereon, removing the resist, and forming a columnar body. Unexamined Japanese Patent Publication No. 2002-279974 (hereinafter referred to as “patent document 3”) proposes a method of disposing a mesh above a current collector, depositing a thin film of negative electrode active material through the mesh, and suppressing the deposit of negative electrode active material in a region corresponding to the frame of the mesh.

Unexamined Japanese Patent Publication No. 2005-196970 (hereinafter referred to as “patent document 4”) also discloses a method of forming undulations of average surface roughness of 0.01 μm to 1 μm on the surface of a current collector, and forming a thin film of negative electrode material thereon at an inclination to a plane perpendicular to the principal plane of the negative electrode material. As a result, the stress caused by expansion and contraction by charging and discharging can be dispersed in directions perpendicular and parallel to the principal plane of the negative electrode material, and occurrence of crease or peeling may be suppressed.

In the secondary batteries disclosed in patent document 1 to patent document 3, a thin film of negative electrode active material is formed in columnar shapes in a normal direction on the convex portion of the current collector, and gaps are formed among the columns, and thereby occurrence of crease or peeling is prevented. However, in order to achieve a high capacity, when the height of the columnar negative electrode active material is increased, or the intervals of gaps are narrowed, in particular, the leading end (open side) of the columnar negative electrode active material is not limited in expansion due to junction with the current collector, and it expands more than the vicinity of the current collector as the charge is progressed. As a result, the columnar negative electrode active materials mutually contact and press near the leading ends, and the current collector and the negative electrode active material may be peeled or the current collector may be wrinkled. In addition, since the contact area of the convex portion of the current collector and the negative electrode active material is small, due to mutual contact of negative electrode active materials or insertion and extraction of lithium ions, the stress of expansion and contraction of negative electrode active material may be concentrated on the junction interface, and the characteristics are likely to decrease due to peeling or the like. On the other hand, when the intervals of gaps are increased, since the negative electrode active material is columnar, the exposed surface area of the current collector is increased, and in the initial phase of charging, in particular, the lithium metal is likely to deposit, thereby causing decrease of safety and capacity. Accordingly, prevention of occurrence of peeling of current collector and negative electrode active material or creasing of current collector, and advancement of capacity could not be satisfied at the same time.

In the structure of the secondary battery disclosed in patent document 4, as shown in FIG. 9A, by negative electrode active material 53 formed at an inclination (θ), deposition of lithium metal duet to widening of exposed area of current collector 51 can be prevented. However, same as in patent document 1 to patent document 3, as shown in FIG. 9B, as the charging progresses, negative electrode active material 53 expands more than the vicinity of current collector 51, and the columnar negative electrode active materials mutually contact near the leading end, and press each other as indicated by an arrow in the drawing, thereby causing peeling of current collector 51 and negative electrode active material 53, or creasing of current collector 51. Further, since gaps 55 are formed near the junction of the negative electrode active material and the current collector, the junction area is small. Accordingly, the stress due to expansion and contraction of negative electrode active material by charging and discharging is concentrated in the junction interface of the negative electrode active material and the convex portion, and as the charging and discharging cycles are advanced, the negative electrode active material is likely to be separated from the junction interface of the convex portion, and the reliability is lowered.

### SUMMARY OF THE INVENTION

The electrode for an electrochemical element of the present invention is an electrode for an electrochemical element for inserting and extracting lithium ions reversibly, and includes at least a current collector forming concave portions and convex portions on one side, a columnar body including an active material formed on the convex portion of the current collector, in which the columnar body covers at least a part of respective sides of the convex portion.

By this configuration, a part of respective sides of the convex portion of the current collector can be covered with the columnar body, and the bond strength can be enhanced. As a result, an electrode for an electrochemical element of high capacity and excellent in charging and discharging cycle characteristics can be realized.

The electrochemical element of the present invention has the electrode for an electrochemical element, a counter electrode for inserting and extracting lithium ions reversibly, and a nonaqueous electrolyte. Hence, a nonaqueous electrolyte secondary battery and an electrochemical element high in safety and excellent in reliability may be manufactured.

### BRIEF DESCRIPTION OF THE DRAWINGS

FIG. 1 is a sectional view of a nonaqueous electrolyte secondary battery having a negative electrode for the nonaqueous electrolyte secondary battery manufactured according to a manufacturing method in an exemplary embodiment of the present invention.

FIG. 2 is a diagram showing a partial sectional SEM photograph of a configuration of the negative electrode in the exemplary embodiment of the present invention.

FIG. 3 is a diagram showing a partial sectional TEM photograph of a configuration of a nanometer size of a columnar body of the negative electrode in the exemplary embodiment of the present invention.

FIG. 4 is a diagram showing results of EELS analysis for explaining a configuration of the nanometer size of the columnar body of the negative electrode in the exemplary embodiment of the present invention.

FIG. 5A is a partial sectional schematic view showing a state before charging of the nonaqueous electrolyte secondary battery in the exemplary embodiment of the present invention.

FIG. 5B is a partial sectional schematic view showing a state after charging of the nonaqueous electrolyte secondary battery in the exemplary embodiment

FIG. 6 is a flowchart for explaining a manufacturing method of a negative electrode for nonaqueous electrolyte secondary battery in the exemplary embodiment of the present invention.

FIG. 7 is an essential schematic view for explaining a film forming device of a negative electrode for nonaqueous electrolyte secondary battery in the exemplary embodiment of the present invention.

FIG. 8A is a partial sectional schematic view for explaining a manufacturing method of a negative electrode for nonaqueous electrolyte secondary battery in the exemplary embodiment of the present invention.

FIG. 8B is a partial sectional schematic view for explaining a manufacturing method of a negative electrode for nonaqueous electrolyte secondary battery in the exemplary embodiment of the present invention.

FIG. 8C is a partial sectional schematic view for explaining a manufacturing method of a negative electrode for nonaqueous electrolyte secondary battery in the exemplary embodiment of the present invention.

FIG. 8D is a partial sectional schematic view for explaining a manufacturing method of a negative electrode for nonaqueous electrolyte secondary battery in the exemplary embodiment of the present invention.

FIG. 9A is a partial sectional schematic view showing a configuration of a state before charging of a conventional negative electrode.

FIG. 9B is a partial sectional schematic view showing a configuration of a state after charging of the conventional negative electrode.

### DETAILED DESCRIPTION OF THE INVENTION

Exemplary embodiments of the present invention are described below while referring to the accompanying drawings, in which same parts are identified with same reference numerals. The present invention is not limited to the following description alone as far as conforming to the basic features described in the specification herein. The electrochemical elements include a nonaqueous electrolyte secondary battery such as a lithium ion secondary battery, or a capacitance element such as a lithium ion capacitor In the following explanation, in particular, the electrode for an electrochemical element is represented by a negative electrode for nonaqueous electrolyte secondary battery, the counter electrode is represented by a positive electrode, and the electrochemical element is represented by a nonaqueous electrolyte secondary battery, but it must be noted that the present invention is not limited by these examples alone.

### EXEMPLARY EMBODIMENT

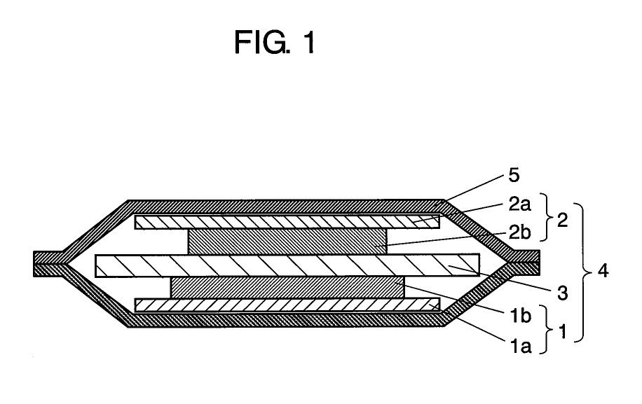

FIG. 1 is a sectional view of a nonaqueous electrolyte secondary battery having a negative electrode for the nonaqueous electrolyte secondary battery manufactured according to a manufacturing method in an exemplary embodiment of the present invention.

As shown in FIG. 1, a laminated type nonaqueous electrolyte secondary battery (hereinafter often referred to as “battery”) includes electrode group 4 composed of negative electrode 1 specifically describe below, positive electrode 2 disposed oppositely to negative electrode 1 for reducing lithium ions at the time of discharging, and porous separator 3 interposed between them for preventing direct contact between negative electrode 1 and positive electrode 2. Electrode group 4 and a lithium ion conductive nonaqueous electrolyte (not shown) are contained inside of outer case 5. The lithium ion conductive nonaqueous electrolyte is impregnated in separator 3. Ends of a negative electrode lead (not shown) and a positive electrode lead (not shown) are connected to negative electrode current collector 1a and positive electrode current collector 2a, other ends are led to outside of outer case 5. The opening of outer case 5 is sealed by a resin material. Positive electrode 2 is composed of positive electrode current collector 2a, and positive electrode mixture layer 2b carried on positive electrode current collector 2a.

More specifically, negative electrode 1 is composed of negative electrode current collector 1a (hereinafter referred to as “current collector”) having concave portions and convex portions, and columnar body 1b disposed for covering at least a part of each side of all sides of protruding parts of a convex portion. The all sides of the convex portion refer to the protruding side from a current collector of the convex portion. Specifically, when the convex portion is formed like a rectangular solid, excluding the bottom, the total is five sides including the top and four sides. When the sectional shape when the convex portion is seen from the top is elliptical or circular columnar, the sides are the top and the side surface of the convex portion.

Herein, positive electrode mixture layer 2b includes LiCoO₂ or LiNiO₂, Li₂MnO₄, or lithium contained composite oxide such as mixed or composite compound of these as positive electrode active material. As positive electrode active material other than these, it is also possible to use olivine type lithium phosphate represented by a general formula of LiMPO₄ (M=V, Fe, Ni, Mn), and lithium fluorophosphate represented by a general formula of Li₂ MPO₄F (M=V, Fe, Ni, Mn). Further, it is preferable to substitute a part of the lithium contained compound with a different type of element. It is also preferable to perform surface treatment with metal oxide, lithium oxide, electro-conductive agent and the like, or to perform hydrophobic treatment of surfaces.

Positive electrode mixture layer 2b further includes a conductive agent and binder. As the conductive agent, it is possible to use graphite such as natural graphite and artificial graphite, carbon black such as acetylene black, ketjen black, channel black, furnace black, lamp black, and thermal black, conductive fiber such as carbon fiber and metal fiber, metal powder such as carbon fluoride and aluminum, conductive whisker such as zinc oxide and potassium titanate, conductive metal oxide such as titanium oxide, and organic conductive material such as phenylene derivative.

Also, as the binder, it is possible to use, for example, PVDF, polytetrafluoroethylene, polyethylene, polypropylene, aramid resin, polyamide, polyimide, polyamide-imide, polyacrylnitrile, polyacrylic acid, methyl ester polyacrylate, ethyl ester polyacrylate, hexyl ester polyacrylate, polymetaacrylic acid, methyl ester polymetaacrylate, ethyl ester polymetaacrylate, hexyl ester polymetaacrylate, polyvinyl acetate, polyvinyl pyrrolidone, polyether, polyether sulfone, hexafluoropolypropylene, styrene butadiene rubber, and carboxymethyl cellulose. Also, it is preferable to use copolymer of two or more kinds of material selected from among tetrafluoroethylene, hexafluoroethylene, hexafluoroprolpylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Also, it is preferable to use a mixture of two or more kinds selected out of these materials.

As positive electrode current collector 2a used for positive electrode 2, it is possible to use aluminum (Al), carbon, conductive resin or the like. Also, it is preferable to use any of these materials surface-treated with carbon or the like.

For nonaqueous electrolyte, it is possible to use an electrolyte solution with a solute dissolved in organic solvent or so-called polymer electrolyte layer immobilized by polymer including the solution. When electrolyte solution is used at least, it is preferable to use separator 3 such as non-woven cloth or fine porous film formed of polyethylene, polypropylene, aramid resin, amidimid, polyphenylene sulfide, polyimide, etc. between positive electrode 2 and negative electrode 1 and to impregnate it with electrolyte solution. Also, the inside or surface of separator 3 is preferable to include a heat resisting filler such as alumina, magnesia, silica, and titania. Besides separator 3, it is preferable to dispose a heat resisting layer formed by the filler and same binder as used for positive electrode 2 and negative electrode 1.

As nonaqueous electrolyte material, it is selected in accordance with the oxidation-reduction potential of each active material. As a solute preferable to be used for nonaqueous electrolyte, it is possible to use salts generally used in lithium battery such as LiPF₆, LiBF₄, LiClO₄, LiAlCl₄, LiSbF₆, LiSCN, LiCF₃SO₃, LiNCF₃CO₂, LiAsF₆, LiB₁₀Cl₁₀, lower aliphatic lithium carboxylate, LiF, LiCl, LiBr, LiI, chloroborane lithium, borates such as bis(1,2-benzenediolate (2-)-O,O′) lithium borate, bis(2, 3-naphthalenediolate (2-)-O,O′) lithium borate, bis(2,3-naphthalenediolate (2-)-O,O′) lithium borate, bis(2,2′-biphenyldiolate (2-)-O,O′) lithium borate, bis(5-fluoro-2-olate-1-venzene sulfonic acid-O,O′) lithium borate, and (CF₃SO₂)₂NLi, LiN(CF₃SO₂)(C₄F₉SO₂), (C₂F₅SO₂)₂NLi, tetraphenyl lithium borate.

Further, as organic solvent in which the above salts are dissolved, it is preferable to use a solvent generally used in a lithium battery such as one kind or a mixture of more kinds of solvents such as ethylene carbonate (EC), propylene carbonate, butylene carbonate, vinylene carbonate, dimethyl carbonate (DMC), diethyl carbonate, ethylmethyl carbonate (EMC), dipropyl carbonate, methyl formate, methyl acetate, methyl propionate, ethyl propionate, dimethoxy methane, γ-prothyrolactone, γ-valerolactone, 1,2-diethoxy ethane, 1,2-dimethoxy ethane, ethoxy-methoxy ethane, trimethoxy methane, tetrahydrofuran derivatives such as tetrahydrofuran, 2-methyl tetrahydrofuran, dimethyl sulfoxide, dioxolane derivatives such as 1,3-dioxolane, 4-methyl 1,3-dioxolane, formamide, acetoamide, dimethyl formamide, acetonitrile, propynitrile, nitromethane, ethylmonoglyme, triester phosphate, ester acetate, ester propionate, sulforan, 3-methyl sulforan, 1,3-dimethyl-2-imidazolidinon, 3-methyl-2-oxazolidinon, propylene carbonate derivative, ethyl ether, diethyl ether, 1,3-propanesalton, anysol, fluorobenzene.

Further, it is preferable to include additives such as vinylene carbonate, cyclohexyl benzene, biphenyl, diphenyl ether, vinyl ethylene carbonate, divinyl ethylene carbonate, phenyl ethylene carbonate, diacryl carbonate, fluoroethylene carbonate, catechol carbonate, vinyl acetate, ethylene sulfite, propane saltone, trifluoropropylene carbonate, dibenzofuran, 2,4-difluoroanysole, o-turphenyl, and m-turphenyl.

It is preferable to use nonaqueous electrolyte in the form of solid electrolyte by mixing the above solvent in one kind or a mixture of more kinds of polymer such as polyethlene oxide, polypropylene oxide, polyphosphazene, polyaziridine, polyethylene sulfide, polyvinyl alcohol, polyfluorovinylidene, and polyhexafluoropropylene. Also, it is preferable to mix the solute with the organic solvent to use it in the form of gel. Further, it is preferable to use organic materials such as lithium nitride, lithium halide, lithium oxygen acid, Li₄SiO₄, Li₄SiO₄—LiI—LiOH, Li₃PO₄—Li₄SiO₄, Li₂SiS₃, Li₃PO₄—Li₂S—SiS₂, and phosphor sulfide compound as solid electrolyte. In the case of using nonaqueous electrolyte gel, it is preferable to dispose the nonaqueous electrolyte gel between negative electrode 1 and positive electrode 2 in place of separator 3. Or, it is preferable to make the arrangement so that nonaqueous electrolyte gel is adjacent to separator 3.

And, metallic foil of stainless steel, nickel, copper, and titanium or thin film of carbon or conductive resin is used for negative electrode current collector 1a of negative electrode 1. Further, it is preferable to treat the surface with carbon, nickel, titanium or the like.

Also, as a negative electrode active material for composing a columnar body of negative electrode 1, it is possible to use negative electrode active material such as silicon (Si) or tin (Sn) whose theoretical capacity density for reversible insertion and extraction of lithium ion exceeds 833 mAh/cm³. Such an active material is able to bring about the advantages of the present invention irrespective of whether it is simple, alloy, compound, solid solution, and composite active material including silicon contained material or tin contained material. That is, as silicon contained material, it is possible to use alloy, compound or solid solution, partially substituting Si with at least one element selected from a group consisting of Al, In, Cd, Bi, Sb, B, Mg, Ni, Ti, Mo, Co, Ca, Cr, Cu, Fe, Mn, Nb, Ta, V, W, Zn, C, N, Sn with respect to Si, SiOx (0<x≦2.0), SiOy (0<y≦2.0), or any one of these. As tin contained material, Ni₂Sn₄, Mg₂Sn, SnOx (0<x<2.0), SnO₂, SnSiO₃, LiSnO can be applied.

These negative electrode active materials can be individually configured, but it is also possible to configure by using a plurality of negative electrode active materials. As an example of configuring a plurality of negative electrode active materials, compound containing Si, oxygen and nitrogen, and composite material of a plurality of compounds including Si and oxygen which are different in composition ratio of Si and oxygen can be mentioned.

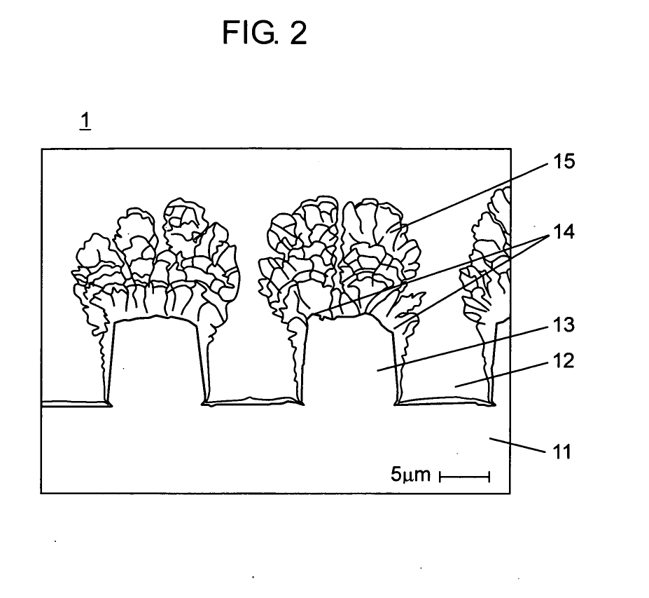

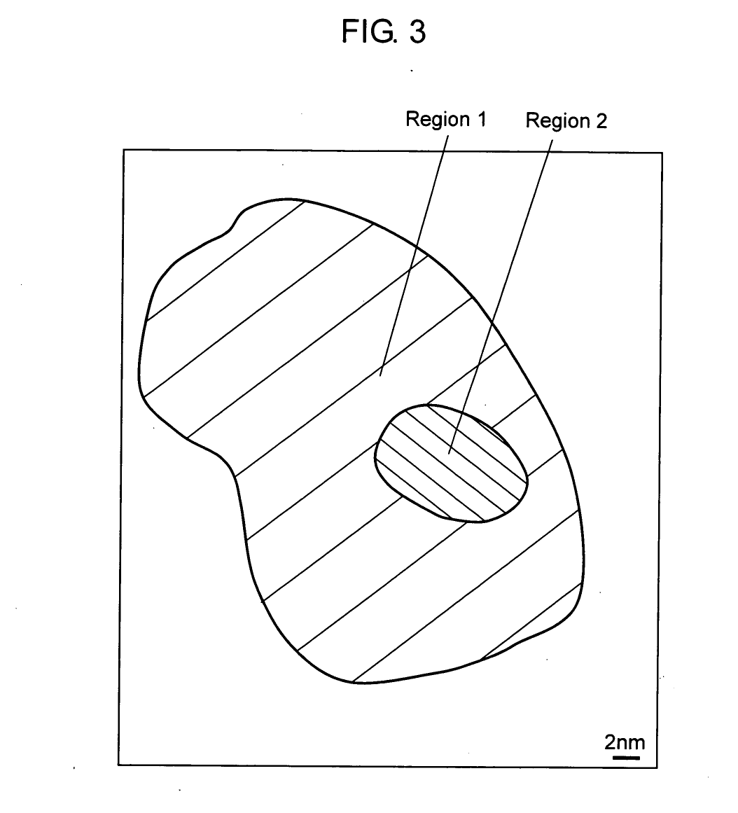

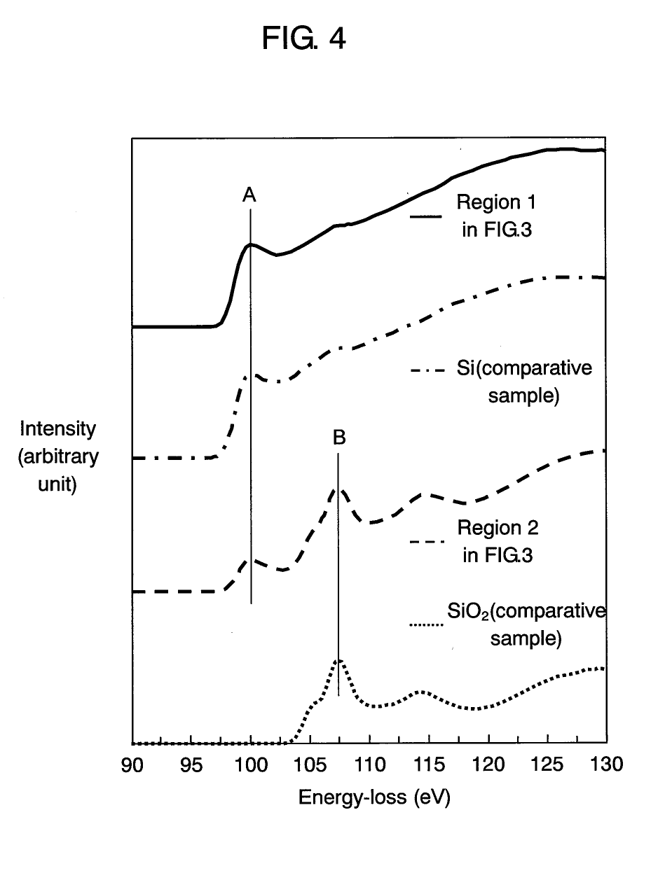

In the exemplary embodiment of the present invention, the negative electrode for nonaqueous electrolyte secondary battery (hereinafter often referred to as “negative electrode”) is explained specifically by referring to FIG. 2, FIG. 3 and FIG. 4. The following explanation relates to an example of negative electrode active material (hereinafter often referred to as “active material”) expressed by SiOx (0≦x≦2.0) or SiOy (0<y≦2.0) containing at least silicon.

FIG. 2 is a diagram showing a partial sectional SEM photograph of a configuration of a negative electrode in the exemplary embodiment of the present invention. FIG. 3 is a diagram showing a partial sectional TEM photograph of a configuration of a nanometer size of a columnar body of a negative electrode in the exemplary embodiment of the present invention. FIG. 4 is a diagram showing results of EELS analysis for explaining a configuration of a nanometer size of the columnar body of a negative electrode in the exemplary embodiment of the present invention.

As shown in FIG. 2, concave portion 12 and convex portion 13 are provided at least on the top of current collector 11 made of conductive metal material such as copper (Cu) foil. To form negative electrode 1 on the top of convex portion 13, the active material expressed as SiOx is formed in a shape of columnar body 15 by using a film forming apparatus (device) such as heat plasma apparatus or RF (radio frequency) plasma apparatus. At this time, columnar body 15 has a shape radially grown from, for example, edge part 14 of convex portion 13 of current collector 11, and covers at least a part of respective sides of all sides of convex portion 13. Since columnar body 15 is grown radially and formed, it is larger than the area of the top of convex portion 13, and the exposed area of convex portion 12 of current collector 11 is smaller. Herein, the all sides of convex portion 13 are, as explained above, the sides projecting from the current collector of the convex portion. For example, in the case of the convex portion formed like a rectangular solid, the all sides are five sides including the top of the convex portion and its four sides, or in the case of a circular convex portion, the all sides are the top of the convex portion and the side surface.

At this time, the composition of columnar body 15 formed of SiOx containing silicon is a nearly uniform SiOx composition in a range larger than a micrometer size, for example, by analysis by EPMA (electron probe micro analyzer).

On the other hand, in a range of a nanometer size, as shown in FIG. 3, as a result of analysis of the columnar body by TEM (transmission electron microscope), columnar body 15 has different material compositions expressed by crystalline Si of about 10 nm (region 1 in the drawing) and noncrystalline SiOy (region 2 in the drawing) (for example, y is a value close to 2). This is confirmed by peaks of line A and line B by analysis by EELS (electron energy loss spectroscopy) shown in FIG. 4. That is, as shown in FIG. 4, region 1 in FIG. 3 is similar to loss energy distribution of Si of comparative material, and region 2 in FIG. 3 is nearly similar to loss energy distribution of SiO₂ of comparative material (for example, thermal oxide film of Si). As a result, region 1 is identified to be crystalline Si, and region 2 is noncrystalline SiOy (y is about 2).

The relation of SiOx and SiOy depends on the dispersion amount of Si and SiOy in a range of a nanometer size, and the value of x of SiOx is determined in a range of a micrometer size. Accordingly, the value of x and the value of y are usually different, and when the fine particle distribution of Si and SiOy is evaluated in the entire columnar body, the average value is expressed by the value of x in SiOx.

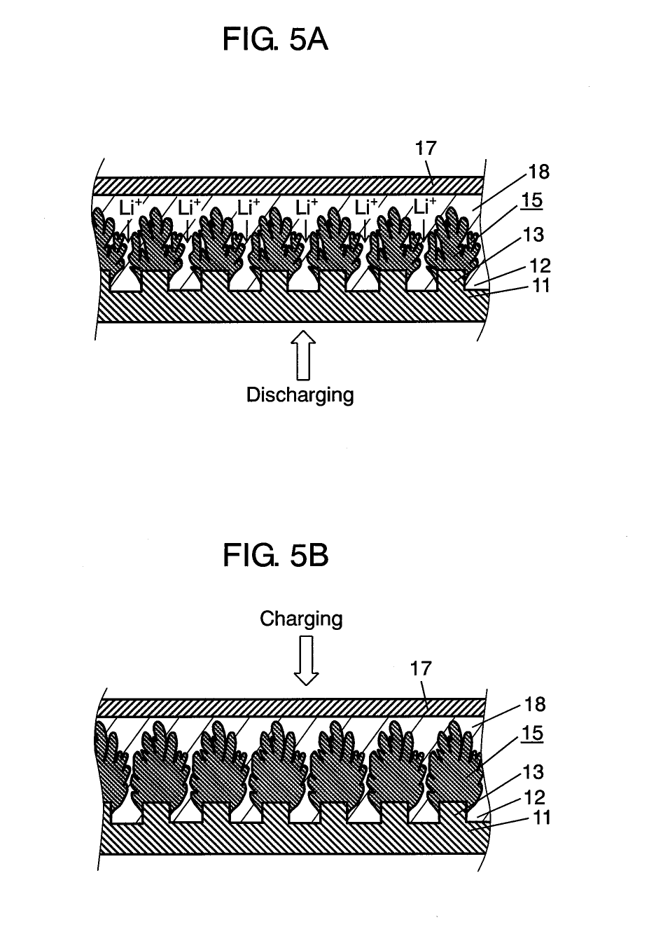

In the nonaqueous electrolyte secondary battery composed by using the negative electrode for nonaqueous electrolyte secondary battery in the exemplary embodiment of the present invention, the charging and discharging operation is described below while referring to FIG. 5A and FIG. 5B.

FIG. 5A is a partial sectional schematic view showing a state before charging of a nonaqueous electrolyte secondary battery in the exemplary embodiment of the present invention, and FIG. 5B is a partial sectional schematic view showing a state after charging of the nonaqueous electrolyte secondary battery in the exemplary embodiment

Columnar body 15 formed radially on convex portion 13 of current collector 11 expands its volume as shown in FIG. 5B, when the nonaqueous electrolyte secondary battery is charged by insertion of lithium ions. When discharged, on the other hand, due to extraction of lithium ions, the volume contracts as shown in FIG. 5A, and columnar body 15 returns to an initial state.

Herein, as shown in FIG. 5A, in charging start state, since columnar body 15 is formed radially on convex portion 13 of current collector 11, when columnar body 15 is seen by projection from positive electrode 17, concave portion 12 of current collector 11 is partially shielded by columnar body 15 for positive electrode 17. Therefore, the lithium ions extracted from positive electrode 17 at the time of charging are shielded by columnar body 15 of the negative electrode and cannot reach directly up to concave portion 12 of current collector 11, and are mostly inserted in columnar body 15, and deposition of lithium metal is suppressed. By insertion of lithium ions, columnar body 15 expands, and if columnar bodies 15 contact with each other, for example, columnar bodies 15 grown radially generally have gaps, and the stress by contact is lessened. Further, since columnar body 15 covers at least a part of respective sides of all protruding sides of convex portion 13 of current collector 11, by enlargement of the contact area, in spite of stress by contact or stress by expansion and contraction of columnar body 15, peeling is less likely to occur, and the reliability may be enhanced outstandingly.

In a range of a nanometer size, since the columnar body is formed of different compositions, such as Si and SiOy, and the expansion amount of Si capable of inserting a large quantity of lithium ions can be lessened by the interposed SiOy smaller in expansion amount. As a result, the inserting amount of lithium ions and the expansion amount of the columnar body can be optimized, and a negative electrode of high capacity and suppressed in disintegration of the columnar body and peeling from the current collector may be realized.

Further, as shown in FIG. 5B, when discharging a completely charged battery, even in columnar body 15 expanded by charging, electrolyte solution 18 may be moved easily through gaps formed in radially grown columnar bodies 15. As a result, since the move of lithium ions is hardly blocked, the high-rate discharge or discharge characteristic at low temperature may be improved.

According to the exemplary embodiment, a nonaqueous electrolyte secondary battery of high capacity and excellent in charging and discharging cycle characteristics may be manufactured.

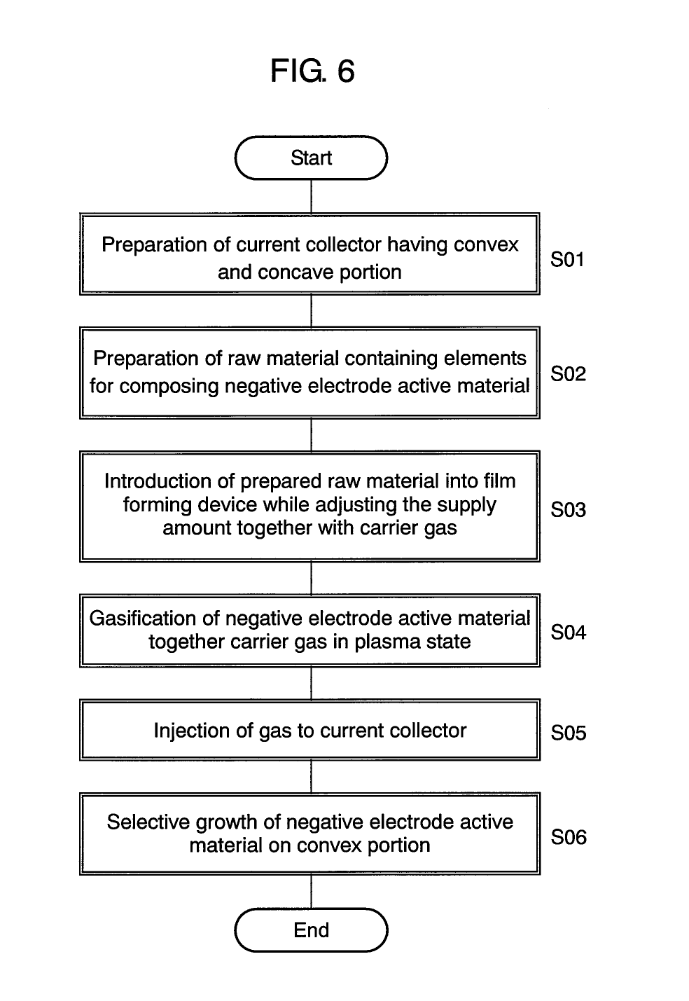

A manufacturing method of a negative electrode for nonaqueous electrolyte secondary battery in the exemplary embodiment of the present invention is specifically described while referring to FIG. 6 to FIG. 8D.

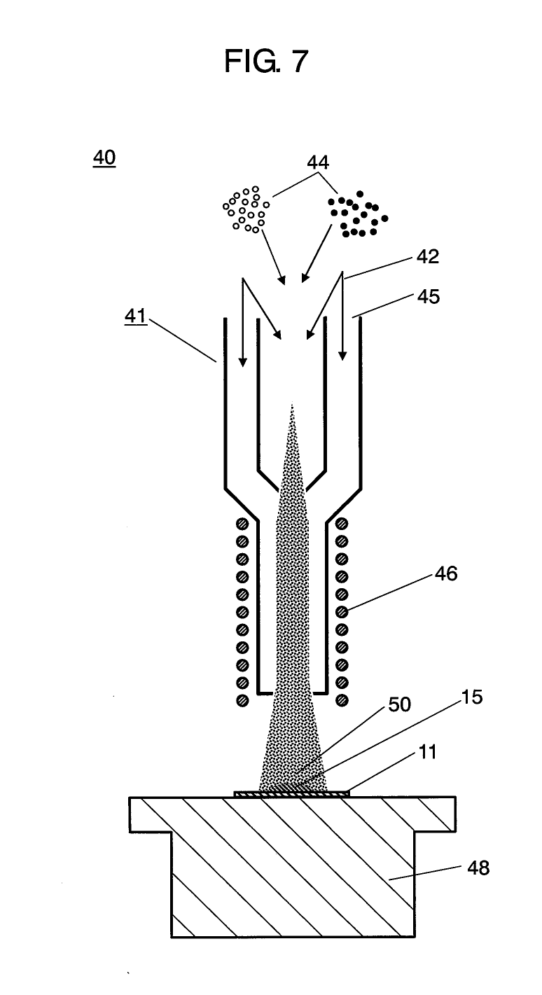

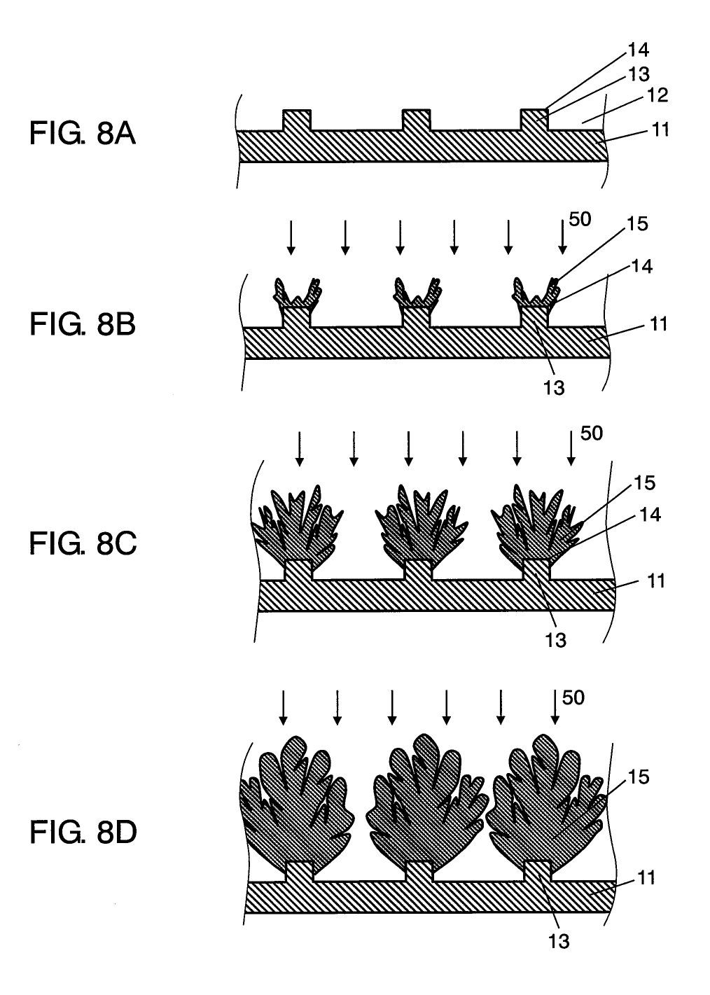

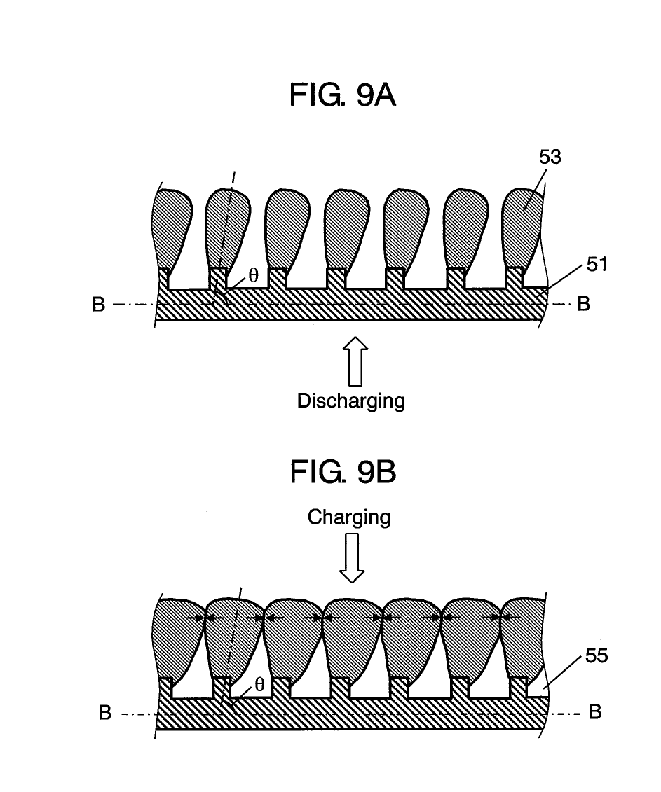

FIG. 6 is a flowchart for explaining a manufacturing method of a negative electrode for nonaqueous electrolyte secondary battery in the exemplary embodiment of the present invention. FIG. 7 is an essential schematic view for explaining a film forming device of a negative electrode for nonaqueous electrolyte secondary battery in the exemplary embodiment of the present invention. FIG. 8A to FIG. 8D are partial sectional schematic views for explaining a manufacturing method of a negative electrode for nonaqueous electrolyte secondary battery in the exemplary embodiment of the present invention.

Film forming device 40 for forming a columnar body shown in FIG. 7 is composed of feed port 45 for feeding carrier gas 42 and active material 44, torch 41 having coil 46 for generating plasma, and stage 48 for installed current collector 11. As required, although not shown, a chamber or a vacuum pump for decompressing stage 48, or a water-cooled device for cooling stage 48 may be provided. FIG. 7 does not show an RF power source for supplying an RF electric power to coil 46, or a feeding device for feeding carrier gas 42 or active material 44.

First, as shown in FIG. 6 and FIG. 8A, using a band-like electrolytic copper foil of 30 μm in thickness, concave portions 12 and convex portions 13 are formed on its surface by plating method, and convex portions 13 formed, for example, in height of 7.5 μm, width of 10 μm, and interval of 20 μm are formed, and current collector 11 is prepared (step S01). Thus, as shown in FIG. 7, current collector 11 is placed on stage 48.

Next, as shown in FIG. 6, raw materials for active material 44 are prepared so as to form a composition for forming columnar body 15 (step SO₂). For example, in the case of columnar body 15 composed of SiOx, supposing the value of x to be 0.25, a mixture of 75 at. % of silicon powder and 25 at. % of silicon oxide is prepared as the raw material.

As shown in FIG. 6 and FIG. 7, while adjusting the supply amount of active material 44 of specified composition, it is supplied from feed port 45 of torch 41 together with carrier gas 42 such as argon (Ar) (step SO₃).

Next, as shown in FIG. 6 and FIG. 7, active material 44 and carrier gas 42 fed into torch 41 are gasified in plasma state having, for example, 8000 K to 10000 K by the RF electric power supplied in coil 46 (step SO₄). Active material 44 gasified in plasma state is injected to current collector 11 on stage 48 from its normal direction (step SO₅). As this time, as specifically described below, by the supply amount and the film deposition rate, active material 44 is cooled near current collector 11 to about thousands of K, and hundreds to thousands of piece are gathered as cluster 50 of a nanometer size, and are adhered to the top of convex portions (not shown) of current collector 11 of which contact surface with the stage is cooled, for example, to temperature of hundreds of ° C.

As a result, an active material is selectively grown in the convex portions of current collector 11, and columnar body 15 is formed (step S06). Although the mechanism of cluster-like substances depositing on the convex portions at high probability is not clear, but this phenomenon is known by the studies by Takamura et al. (Journal of Vacuum Science and Technology B Vol. 15, issue 3, 1997, pp. 558-565). However, it is not known that active material 44 is grown selectively on convex portions 13, and the present invention is realized on the basis of new findings of the phenomenon of selective growth of cluster-like substances on the convex portions.

The mode of selective forming of active material on the convex portions 13 of current collector 11 at step S06 is schematically explained by referring to FIG. 8A to FIG. 8D.

First, as shown in FIG. 8B, active material 44 injected in a state of cluster 50 of a nanometer size starts to grow mainly from edge part 14 of convex portion 13. Depending on the condition, the growth may not always start from edge part 14. Generally it is estimated to depend on the magnitude of a solid angle, but the columnar body is likely to grow from the vicinity of edge part having the large solid angle.

Next, as shown in FIG. 8C, active material 44 grows radially from edge part 14, and covers at least a part of respective sides of convex portion 13. At this time, the radial growth is likely to occur in the case of square columnar convex portion 13, but in the case of a conical shape or the like, since the edge is one point, the growth in one direction is likely to occur.

Further, as shown in FIG. 8D, finally, columnar body 15 having a specified height is formed.

In this process, a negative electrode having columnar body 15 selectively formed radially (like cauliflower) on the convex portion of current collector 11 is manufactured.

According to this exemplary embodiment, the columnar body covers at least a part of respective sides of the convex portion, and the junction area is enlarged, and the junction strength is increased. If the columnar body expands and contracts by charging and discharging cycles, and the stress is concentrated in the junction interface, peeling hardly occurs, and the negative electrode of long life and excellent reliability is realized. Besides, since the columnar body is formed and grown radially from the edge part of the convex portion, the exposure area of the current collector is decreased, and the columnar body is increased in volume. As a result, by this negative electrode, a nonaqueous electrolyte secondary battery of high capacity and excellent in charging and discharging cycle characteristics is realized.

According to the exemplary embodiment, the composition of the formed columnar body is a uniform composition in a range of more than micrometer size, but in a range of a nanometer size, for example, the negative electrode has different compositions, for example, in crystalline Si and noncrystalline SiOy (y is a value close to 2). At this time, the formed composition is determined by the active material ingredient to be introduced in the film forming device, for example, the composition of SiOx.

As a result, in a range of more than a micrometer size, a uniform composition is obtained regardless of the position in the columnar body, and in a range of a nanometer size, by the structure of uniform dispersion of different compositions, the stress by expansion and contraction by insertion and extraction of lithium ions can be lessened, and a stable columnar body hardly causing peeling, crack or dropout may be formed.

In the exemplary embodiment, the convex portion of the current collector is a square columnar shape, but this is not limited. For example, it may be formed in triangular or trapezoidal sectional shape, and conical or pyramidal shape may be formed, or flat rhombic polyhedral shape of convex portion may be formed, or circular or elliptical shape may be formed. Convex portions of various shapes may be combined to form a current collector. As a result, the columnar body grows radially mainly from the edge part of the convex portion, and depending on the shape of the convex portion, flame-like or cauliflower-like shape may be formed. Hence, the exposure area of the current collector is further decreased, and a reliable negative electrode hardly depositing the lithium metal may be manufactured.

In the exemplary embodiment, the columnar body is formed on the convex portion of the current collector having concave and convex portions, but not limited to this example, the shape is not particularly specified as far as the surface shape of the current collector allows to form the columnar body of such various shapes selectively. Not limited to the convex portion of the current collector, the columnar bodies may be formed in a random configuration, and the negative electrode of higher capacity may be manufactured.

In the exemplary embodiment, further, as the electrode for electrochemical element, an example of negative electrode for nonaqueous electrolyte secondary battery is shown, but this is not limited. For example, same effects are obtained when applied in a capacity element in an electrode for lithium ion capacitor.

The embodied example of the present invention is specifically described below by presenting various samples. The present invention is not limited to the following embodied examples alone, but may be changed and modified by other ingredients or the like within the scope not departing from the true spirit and scope of the prevent invention.

### First Embodied Example

First, the columnar body of the negative electrode was manufactured by using the RF plasma film forming device shown in FIG. 7.

On the surface of a current collector, by plating method, convex portions were formed by using a band-like electrolytic copper foil of 5 μm in height, 10 μm in width, 20 μm in interval, and 30 μm in thickness.

As an active material ingredient for the negative electrode, Si powder 75 at. % and SiO powder 25 at. % were used, and as carrier gas, a mixed gas of Ar/H₂ was blended at a ratio of 50 (liters/min.)/10 (liters/min.), and the both were supplied from the feed port of the torch. The supplied active material and carrier gas were gasified in plasma state by applying an RF electric power of 30 kW to the coil. The gasified active material in plasma state was injected toward the current collector placed at a position of 250 mm from the torch, and the columnar body grown radially was formed on the convex portion. This operation was done at internal pressure of 26 kPa (about 0.26 atmospheres) in the container.

The shape of the columnar body of the negative electrode was evaluated by observing the section by using a scanning electron microscope (S-4700 manufactured by Hitachi), and as shown in FIG. 2, the columnar body covered a part of respective sides of the convex portion, and was formed radially. At this time, the thickness (height) of the formed columnar body was 16 μm in the normal direction.

Using an EPMA, the oxygen distribution was investigated by linear measurement in sectional direction of the columnar body for composing the negative electrode in a micrometer size, and a nearly uniform composition of SiOx was observed. At this time, the value of x was 0.25, and was nearly same as the composition in supplying. Using a TEM (JEM-2010F manufactured by JEOL), in a nanometer size in a range of, for example, 50 nm, the columnar body was analyzed, and different compositions of Si and SiOy were dispersed uniformly. At this time, the value of y was almost 2.

The negative electrode having the columnar body grown radially on the convex portion of the current collector was obtained.

Later, on the surface of the negative electrode, Li metal of 11 μm was deposited by vacuum deposition method. At the inner peripheral side of the negative electrode, an exposure part was provided in the Cu foil not opposite to the positive electrode, and a negative electrode lead made of Cu was welded.

Next, a positive electrode having a positive electrode active material capable of inserting and extracting lithium ions was manufactured in the following procedure.

Firstly, 93 parts by weight of LiCoO₂ powder as a positive electrode active material and 4 parts by weight of acetylene black as a conductive agent are mixed. A N-methyl-2-pyrrolidone (NMP) solution including polyvinylidene fluoride (PVDF) (#1320, Kureha Kagaku) as a binder is mixed to the powder so that the weight of PVDF becomes 3 parts by weight. A proper amount of NMP was added to this mixture, and a positive electrode mixture paste was prepared. The positive electrode mixture paste was applied on both sides of the current collector by doctor blade method, on the positive electrode current collector (thickness 15 μm) made of aluminum (Al) foil, and was rolled to the density of positive electrode mixture layer of 3.5 g/cc and thickness of 140 μm, and was dried sufficiently at 85° C., and it was cut out and a positive electrode was obtained. An exposure area was provided in the Al foil not opposite to the negative electrode at the inner peripheral side of the positive electrode, and a positive electrode lead made of Al was welded.

Thus, the negative electrode and the positive electrode were manufactured, and were laminated by way of a separator made of porous polypropylene of 25 μm in thickness, and an electrode group of 40 mm×30 mm square was composed. The electrode group was impregnated in an electrolyte solution of LiPF₆ dissolved in a non-aqueous solvent containing a mixed solution of ethylene carbonate/dimethyl carbonate, and was put in an outer case (material: aluminum), and the opening of the outer case was sealed, and a laminated type battery was manufactured. The design capacity of the battery was 40 mAh. This is called sample 1.

### Comparative Example 1

The active material layer of 8 μm in height (thickness) was formed on the entire surface of the current collector on a flat band-like electrolytic copper foil of 30 μm in thickness by using an ordinary electron beam device. At this time, as deposition source of the active material, scrap silicon (purity 99.999%) was used. Simultaneously with evaporation of deposition source, oxygen of high purity (for example, 99.7%) was blown from the nozzle disposed near the current collector, and SiOx was deposited.

The formed active material layer was observed by EPMA, and the oxygen distribution was investigated by linear distribution measurement in sectional direction of a micrometer size, and the SiOx was formed where the value of x in thickness direction was slightly deviated from 0.25.

The nonaqueous electrolyte secondary battery manufactured by the same method as in first embodied example except that the negative electrode obtained herein was used is sample C1.

### Comparative Example 2

As the current collector, a band-like electrolytic copper foil of 30 μm in thickness was used by forming a convex portion on the surface at intervals of 20 μm by plating method.

Same as in comparative example 1, using an electron beam device, SiO_{0.25} was used as active material ingredient of the negative electrode, and a columnar body was formed by using deposition unit (a unit assembly including deposition source, crucible, and electron beam generator). At this time, the inside of the vacuum container was an argon atmosphere at pressure of 10⁻³ Pa. At this time of deposition, an electron beam generated by the electron beam generator was deflected by a deflection yoke, and was emitted to the deposition source (scrap silicon, purity: 99.999%). Simultaneously with evaporation of deposition source, oxygen of high purity (for example, 99.7%) was blown from the nozzle disposed near the current collector, and SiOx was deposited.

The columnar body was formed at film deposition rate of about 8 nm/s by setting the deposition angle ω at 60° to the normal direction of the current collector. As a result, the columnar body of 15 μm in height was formed.

The oblique angle of the columnar body in the negative electrode to the central line of the current collector was evaluated by observing the section by using an electron scanning microscope (S-4700 manufactured by Hitachi), and was about 41 degrees. At this time, the thickness of the formed columnar body was 15 μm.

The formed columnar body was observed by EPMA, and the oxygen distribution was investigated by linear distribution measurement in sectional direction of a micrometer size, and the SiOx was formed where the value of x was slightly deviated from 0.25.

The nonaqueous electrolyte secondary battery manufactured by the same method as in first embodied example except that the negative electrode obtained herein was used is sample C2.

These samples of nonaqueous electrolyte secondary battery were evaluated as follows.

(Measurement of Battery Capacity)

The nonaqueous electrolyte secondary batteries were charged and discharged in the following conditions at an ambient temperature of 25° C.

At design capacity (40 mAh), the batteries were charged up to the battery voltage of 4.2 V at constant current of hour rate of 1.0 C (40 mA), and were charged at constant voltage while attenuating to the current value of hour rate of 0.05 C (2 mA) at constant voltage of 4.2 V. Then, the battery was in a rest for 30 minutes.

Then the batteries were discharged at constant current until the battery voltage was lowered to 3.0 V at the current value of hour rate of 0.2 C (8 mA).

The total process was one cycle, and the discharge capacity at the third cycle was recorded as the battery capacity.

(Measurement of Electrode Capacity Density)

After measurement of battery capacity, the batteries were further charged in a fourth cycle, and were decomposed, and the thickness of the columnar body of the negative electrode was measured from a sectional direction of the electrode by a scanning electron microscope. The capacity per unit weight (mAh/g) was calculated from the discharge capacity (mAh) at the third cycle and the weight of the columnar body before charging, and the electrode capacity density of negative electrode (mAh/cm³) was calculated from the thickness (μm) of columnar body of negative electrode after charging and the weight per unit area (mg/cm²) of columnar body before charging and discharging, and the results were evaluated.

(Charging and Discharging Cycle Characteristics)

The nonaqueous electrolyte secondary batteries were charged and discharged repeatedly in the following conditions at an ambient temperature of 25° C.

At design capacity (40 mAh), the batteries were charged up to the battery voltage of 4.2 V at constant current of hour rate of 1.0 C (40 mA), and were charged at constant voltage of 4.2 until lowered to the current value of hour rate of 0.05 C (2 mA). After charging, the battery was in a rest for 30 minutes.

Then the batteries were discharged at a constant current until the battery voltage was lowered to 3.0 V at a current value of hour rate of 1.0 C (40 mA).

The total process was one cycle, and the operation of charging and discharging was repeated 100 cycles. The rate of discharge capacity at 100th cycle with respect to the discharge capacity at the first cycle was expressed in percentage, and the capacity retaining ratio (%) was determined. That is, when the capacity retaining ratio is closer to 100, it shows the charging and discharging cycle characteristics are better.

(Observation of Electrode State)

After 100 cycles of discharging, the batteries were decomposed, and by visual inspection and by using a scanning electron microscope (SEM), peeling and dropping of the active material or the columnar body from the current collector, and deformation of the current collector were observed, and the electrode state was evaluated.

Specifications and evaluation results of sample 1 and sample C1, C2 are shown in Table 1 and Table 2.

TABLE 1

| | | | Columnar | Electrode | |
|---|---|---|---|---|---|
| | Film | Oblique | body | capacity | |
| | forming | angle | thickness | density | Value of |
| | device | (°) | (μm) | (mAh/cm³) | x in SiOx |
| Sample 1 | RF plasma | 0 | 16 | 1160 | 0.25 |
| Sample C1 | Electron | 0 | 8 | 750 | ≈0.25 |
| | beam | | | | |
| Sample C2 | Electron | 41 | 15 | 1030 | ≈0.25 |
| | beam | | | | |

TABLE 2

| | No. of | Electrode state | | Capacity |
|---|---|---|---|---|
| | cycles | Peeling of | Deformation of | retaining |
| | (times) | columnar body | current collector | ratio (%) |
| Sample 1 | 10 | — | — | 98 |
| | 100 | Absent | Absent | 85 |
| Sample C1 | 10 | — | — | 97 |
| | 100 | Present | Present | 50 |
| Sample C2 | 10 | — | — | 98 |
| | 100 | Absent | Present | 75 |

As shown in Table 1, comparing the electrode capacity density of sample 1, sample C1, and sample C2, the electrode capacity density of sample 1 was higher than the electrode capacity density of sample C1 and sample C2. It is estimated because the composition of the active material for composing the columnar body is uniform in a range of a micrometer size, and is capable of inserting and extracting a greater quantity of lithium ion. In sample C1, the lithium ion is inserted and extracted mainly on the outermost surface of the active material, while in sample C2, the lithium ion is inserted and extracted on the entire surface of the columnar body, and therefore if the composition is slightly deviated, the electrode capacity density seems to be higher.

As shown in Table 1 and Table 2, comparing sample 1, sample C1, and sample C2, in the initial phase, that is, about first 10 cycles, there was no difference in the capacity retaining ratio. In 100 cycles, however, sample 1 recorded about 85% of capacity retaining ratio, sample C1 dropped to about 50% of capacity retaining ratio, and sample C2 also decreased to about 75% of capacity retaining ratio.

In sample C1, the active material is formed in the entire surface of current collector opposite to the positive electrode, and therefore by expansion and contraction due to insertion and extraction of lithium ion seem to cause peeling or dropping of the active material from the current collector as the number of cycles increased. In sample C2, since the columnar body is formed obliquely and discretely from the current collector, stress by expansion and contraction can be lessened, and peeling or dropout of columnar body is hardly observed. However, by the moment of the stress applied to the apex of the oblique columnar body contacting with the positive electrode through the separator, the current collector is creased or deformed, and it seems that efficient charging or discharging is limited, thereby lowering the capacity retaining ratio.

On the other hand, in sample 1, by the columnar body covering at least a part of respective sides of all sides of the convex portion of the current collector and formed in the normal direction of the current collector, the bond strength to the current collector is enhanced, and deformation of the current collector by moment is hardly caused, thereby decreasing occurrence of crease or distortion of the current collector or peeling or dropout of the columnar body. In a range of a nanometer size, since the columnar body is formed of compositions different in expansion and contraction amount, and the expansion stress and the contraction stress can be lessened between different compositions.

Also as shown in Table 1, in sample 1, the columnar body is formed of a uniform composition in a range of a micrometer size, but in sample C1 and sample C2, the columnar body is formed at deviation from design composition (x=0.25) or at partial deviation in composition within the columnar body. This is considered to be due to the film forming method. That is, in the electron beam method, the composition of the deposition source changes in the course of use, and the reaction of evaporating particles and the oxygen bonding during flight may not be uniform. In sample 1, the composition may be uniform by control of the composition of the supplied materials, and when forming on a current collector, a cluster state of a nanometer size of uniform composition is grown, and a columnar body not deviated in composition is formed.

As described herein, by the negative electrode for nonaqueous electrolyte secondary battery having the columnar body formed radially and uniform in composition at least in a range of a micrometer size, it is confirmed that a nonaqueous electrolyte secondary battery of high reliability and excellent capacity maintenance rate can be realized.

In the exemplary embodiment, for example, Si and SiOx are used as an active material of a columnar body, but the elements are not particularly specified as far as lithium ions can be inserted and extracted reversibly, and preferably at least one may be selected from Al, In, Zn, Cd, Bi, Sb, Ge, Pb and Sn. The active substrate may also contain other material than the elements mentioned above, and may also contain, for example, transition metal or group 2A element.

In the present invention, the shape of convex portions and forming intervals formed on the current collector are not limited to the conditions mentioned in the exemplary embodiment, and the shape is not particularly specified as far as columnar bodies grown radially for covering at least a part of respective sides of all sides of the convex portion are formed.

The oblique angle formed by the central line of the columnar body and the central line of the current collector, and the shape and dimensions of the columnar body are not particularly limited to the conditions in the exemplary embodiment, but may be properly changed depending on the manufacturing method of negative electrode or the required conditions of the nonaqueous electrolyte secondary battery.

In the present invention, as the electrochemical element, the nonaqueous electrolyte secondary batteries such as the lithium ion secondary battery are shown, but not limited to these examples, and the present invention may be applied to the capacity elements such as the lithium ion capacitor.

What is claimed is:

1. An electrode for an electrochemical element for inserting and extracting a lithium ion reversibly, comprising:
a current collector forming a concave portion and a convex portion at least on one side; and
a columnar body including an active material formed on the convex portion of the current collector,
wherein the columnar body covers at least a part of respective sides of the convex portion.

2. The electrode for an electrochemical element of claim 1,
wherein the columnar body has the active material grown radially.

3. The electrode for an electrochemical element of claim 1,
wherein the composition of the columnar body is uniform in a range of a micrometer size or larger.

4. The electrode for an electrochemical element of claim 1,
wherein the columnar body has at least two different compositions in a range of a nanometer size.

5. The electrode for an electrochemical element of claim 1,
wherein the active material is at least a material capable of inserting and extracting a lithium ion reversibly, and having a theoretical capacity density of more than 833 mAh/cm³.

6. The electrode for an electrochemical element of claim 5,
wherein the material is a material expressed by SiOx at least containing silicon.

7. The electrode for an electrochemical element of claim 4,
wherein the columnar body is composed of different materials at least expressed by Si and SiOy in a range of the nanometer size.

8. An electrode for an electrochemical element for inserting and extracting a lithium ion reversibly, comprising:
a current collector; and
a columnar body including an active material formed radially on the current collector.

9. An electrochemical element comprising:
an electrode for an electrochemical element of any one of claims 1 to 8;
a counter electrode for inserting and extracting a lithium ion reversibly; and
a nonaqueous electrolyte.
